(19) United States
(12) Patent Application Publication
(10) Pub. No.: US 2016/0167320 A1
(43) Pub. Date: Jun. 16, 2016

(54) SELF-PIERCING RIVET

(71) Applicant: Hyundai Motor Company, Seoul (KR)

(72) Inventors: Jeong Min Cho, Suwon (KR); Chi Hoon Choi, Suwon (KR); Kyung Bum Kang, Bucheon (KR); Soon Hong Park, Seoul (KR)

(21) Appl. No.: 14/874,659

(22) Filed: Oct. 5, 2015

(30) Foreign Application Priority Data
Dec. 10, 2014 (KR) 10-2014-0177755

(51) Int. Cl. B29C 73/06; F16B 19/00

(52) U.S. Cl. CPC B29C 73/06; F16B 19/008; B29K 2063/00

(57) ABSTRACT

A self-piercing rivet which reduces damage of a composite part and enhances bonding capability by suppressing galvanic corrosion is provided. The self-piercing rivet includes a repair resin that is disposed in a space formed within the rivet and a passage that is formed between an inner surface forming the space and an outer surface of the rivet and through which the repair resin flows.

### CROSS-REFERENCE(S) TO RELATED APPLICATIONS

The present application claims priority to Korean Patent Application No. 10-2014-0177755, filed Dec. 10, 2014, the entire contents of which is incorporated herein for all purposes by this reference.

### BACKGROUND

1. Field of the Invention

The present invention relates to a self-piercing rivet which reduces damage of a composite part and enhances joining capability by suppressing galvanic corrosion.

2. Description of Related Art

FIG. 1 shows an existing self-piercing rivet (SPR) according to the related art. The self-piercing rivet includes a head portion 101 and the shank portion 103 and is made of a typical metal material such as steel. When a carbon fiber composite is joined to a metal material using the self-piercing rivet, the composite may be locally damaged around an aperture formed in the process of punching the carbon fiber composite using the rivet. In addition, galvanic corrosion may occur between the rivet as a metal material and the carbon fiber composite, thereby causing the joint strength and durability to be deteriorated.

The matters described as the related art have been provided merely for assisting the understanding for the background of the present invention and should not be considered as corresponding to the related art already known to those skilled in the art.

### SUMMARY

An exemplary embodiment of the present invention is directed to a self-piercing rivet which reduces damage of a composite part and enhances joining capability by suppressing galvanic corrosion when parts are joined using the self-piercing rivet. Other objects and advantages of the present invention can be understood by the following description, and become apparent with reference to the exemplary embodiments of the present invention. Also, it is obvious to those skilled in the art to which the present invention pertains that the objects and advantages of the present invention can be realized by the means as claimed and combinations thereof.

In accordance with an exemplary embodiment of the present invention, a self-piercing rivet may include a repair resin disposed in a space formed within the rivet, and a passage formed between an inner surface forming the space and an outer surface of the rivet to allow the repair resin to flow in the passage. The repair resin may include a thermosetting resin and a hardener. The thermosetting resin and the hardener may be accommodated in a separated state by a separation membrane.

The space may be formed in an aperture at the center of one end portion of the body portion of the rivet, and the passage may be penetrated and formed between an inner surface of the body portion abutting the repair resin and an outer surface of the body portion. One end portion of the passage may be connected to an inner end portion forming the space. The passage may be radially formed based on an axial center of the body portion. A flow groove may be formed on the outer surface of the rivet to be connected to the other end portion of the passage. The flow groove may be formed in a circumferential direction of the rivet. The flow groove may be formed in a circumferential direction of the rivet to have a spiral shape.

The self-piercing rivet may further include an insulation unit disposed to surround the outer surface of the rivet and insulating parts abut with the rivet. The insulation unit may include an insulation layer formed on the outer surface of the rivet and may have a rubber member. The insulation layer may be configured by coating a resin on the rubber member and may be disposed on the outer surface of the rivet through a resin layer.

### BRIEF DESCRIPTION OF THE DRAWINGS

FIG. 1 is an exemplar view showing a configuration of an existing self-piercing rivet according to the related art;

FIG. 2 is an exemplary cross-sectional view showing a configuration of a self-piercing rivet according to an exemplary embodiment of the present invention;

FIG. 3 is an exemplary view showing a first configuration example of a flow groove on the self-piercing rivet according to the exemplary embodiment of the present invention;

FIG. 4 is an exemplary view showing a second configuration example of a flow groove in the self-piercing rivet according to the exemplary embodiment of the present invention; and

FIG. 5 is an exemplary view illustrating an exemplary state in which parts are joined using the self-piercing rivet according to the exemplary embodiment of the present invention.

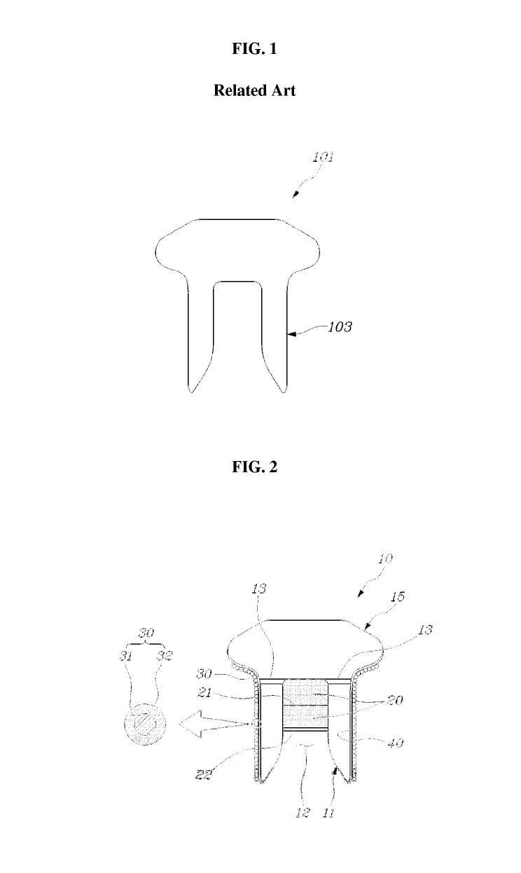

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Exemplary embodiments of the present invention will be described below in more detail with reference to the accompanying drawings. The present invention may, however, be embodied in different forms and should not be construed as limited to the exemplary embodiments set forth herein. Rather, these exemplary embodiments are provided so that this disclosure will be thorough and complete, and will fully convey the scope of the present invention to those skilled in the art. Throughout the disclosure, like reference numerals refer to like parts throughout the various figures and exemplary embodiments of the present invention.

A self-piercing rivet 10 according to an exemplary embodiment of the present invention may include a repair resin 20 and a passage 13. The present invention will be described in detail with reference to FIG. 2. First, the repair resin 20 may be disposed into a space 12 formed in the rivet 10. For example, the rivet 10 may be divided into an upper head portion 15 and a lower body portion 11. The space 12 may be formed in an aperture at the center of one end portion of the body portion 11, and the repair resin 20 may be accommodated into the aperture.

In particular, the repair resin 20 may include a hardener together with a thermosetting resin. The thermoset resin and the hardener may be disposed in a separated state (e.g., in separate portions, areas, or the like or are separated) by a separation membrane 21. Further, an epoxy resin may be used as an example of the thermoset resin and the hardener may be a known hardener added to the thermosetting resin to perform hardening by cross-linkage.

The separation membrane 21 may prevent the epoxy resin from mixing with the hardener, and may be designed to have a structure and a material capable of being damaged or torn when an external force by bonding of the rivet 10 is applied to the separation membrane 21. Additionally, the positions of the epoxy resin and the hardener divided by the separation membrane 21 may vary. The present invention may be designed as a structure in which the epoxy resin and the hardener are mixed by damage or tearing of the separation membrane 21. To prevent the repair resin 20 from flowing out of the space 12 when the repair resin 20 is a liquid, a shield membrane 22 may be formed to shield a portion of the space 12. In particular, the shield membrane 22 may prevent separation of the repair resin 20, and may be designed to have a structure and a material capable of being damaged or torn when an external force by bonding of the rivet 10 is applied to the shield membrane 22.

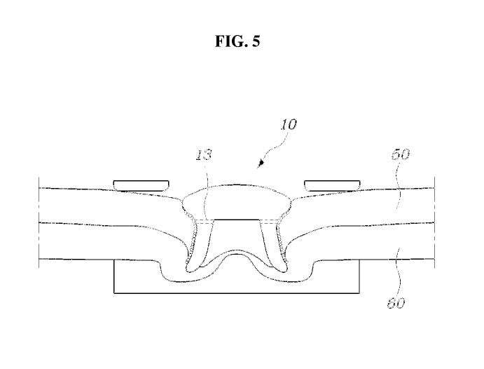

Furthermore, the passage 13 may be formed between an inner surface forming the space 12 and an outer surface of the rivet 10 to allow the repair resin 20 to flow in the passage 13. Accordingly, the repair resin 20 may flow out to the outer surface of the rivet 10 through the passage 13 during bonding of the rivet 10. In other words, when a carbon fiber composite 50 is joined to a metal material 60 using the self-piercing rivet 10 as shown in FIG. 5, the repair resin 20 may flow out to the outer surface of the rivet 10 through the passage 13 while the separation membrane 21 may be damaged by pressure applied to the repair resin 20 when the lower body portion 11 of the rivet 10 penetrates into the composite. Particularly, the repair resin 20 may be hardened at a bonded layer portion of the rivet 10 by the hardener included in the repair resin 20. Therefore, the present invention may reduce damage of the bonded layer caused during the bonding of the rivet 10 and enhance joining strength and bonding capability.

Moreover, in the present invention, the passage 13 may be penetrated and formed between an inner surface of the body portion 11 abutting (e.g., formed in contact with) with the repair resin 20 and an outer surface of the body portion 11. One end (e.g., a first end) portion of the passage 13 may be connected to a deepest portion of the inner surface of the body portion 11 forming the space 12. In other words, the repair resin 20 accommodated in the space 12 may not remain in the space 12 and may flow out to the outer surface of the rivet 10 during the bonding of the rivet 10. Consequently, the bonding capability by the rivet 10 may be further enhanced.

In addition, the passage 13 may be formed radially based on an axial center of the body portion 11. For example, the passage 13 may be penetrated between the inner surface of the space 12 and the outer surface of the body portion 11 and be formed at both sides. However, two or more passages may also be formed if necessary. A flow groove 14 may be formed on the outer surface of the rivet 10 to be connected to the other end (e.g., a second end) portion of the passage 13.

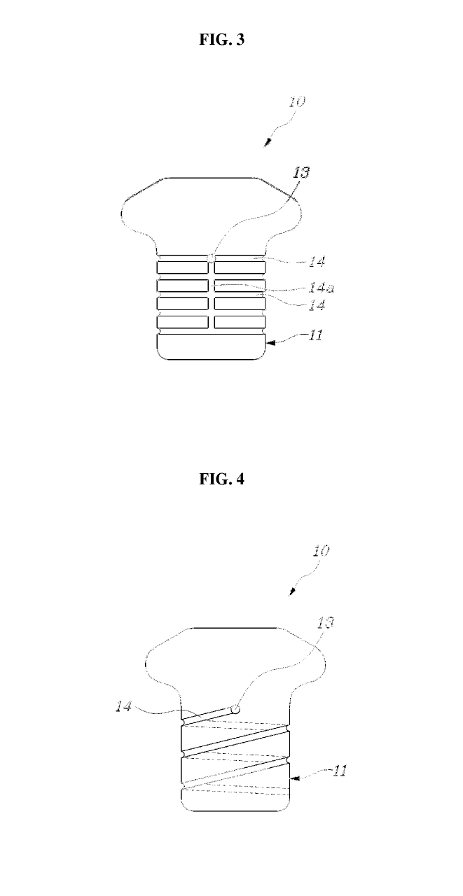

A first configuration example of the flow groove 14 will be described with reference to FIG. 3. The flow groove 14 may be formed in a circumferential direction of the rivet 10. For example, one flow groove 14 or two or more flow grooves 14 may be formed in the circumferential direction of the body. When a plurality of flow grooves 14 are formed, a flow connection groove 14a may be formed between the adjacent flow grooves 14 to connect the flow grooves 14. Consequently, the repair resin 20 flowing out of the passage 13 may be bonded to a part abutting with the rivet 10, for example, to a punched portion of the carbon fiber composite 50 while flowing along the flow grooves 14 and the flow connection groove 14a.

A second configuration example of the flow groove 14 will be described with reference to FIG. 4. The flow groove 14 may be formed in the circumferential direction of the rivet 10 to have a spiral shape. In other words, the repair resin 20 flowing out of the passage 13 may be bonded to a part abutting with the rivet 10 while flowing along the flow groove 14 having a spiral shape. Through such a configuration, since the repair resin 20 flowing out of the passage 13 may be bonded to the part abutting with the rivet 10 while flowing along the outer surface of the rivet 10, the present invention may further enhance the joining strength and bonding capability of the rivet 10.

Meanwhile, the present invention may further include an insulation unit disposed to surround the outer surface of the rivet 10 and insulate parts abutting with the rivet 10. Specifically, the insulation unit may include an insulation layer 30 formed on the outer surface of the body portion 11 of the outer surface of the rivet 10 and a portion of the bottom surface of the head portion 15. In particular, in the insulation layer 30, a coating layer 32 made of resin may be formed on a rubber member 31 having particles of about the same size as microsphere.

In addition, the insulation layer 30 may be disposed on the outer surface of the rivet 10 through a resin layer 40. In other words, after the resin layer 40 having a thickness of about several tens of micrometers is applied on the surface of the rivet 10, the insulation layer 30 may be applied on the resin layer 40. Particularly, a resin used to coat the insulation layer 30 and a resin used for the resin layer 40 may be a thermosetting resin, for example, an epoxy resin. According to the above configuration, the insulation layer 30 applied on the surface of the rivet 10 may insulate the rivet 10 from the parts such as the carbon fiber composite 50 and the metal material 60 during the bonding of the rivet 10, as shown in FIG. 5. Consequently, the present invention may prevent galvanic corrosion caused between the rivet 10 and the peripheral parts.

In accordance with the exemplary embodiments of the present invention, a repair resin may be introduced into a bonded layer portion of a rivet to reduce damage of the bonded layer portion and to improve joining capability between parts. In addition, it may be possible to prevent a risk of galvanic corrosion through insulation between the rivet and peripheral parts bonded thereto.

While the present invention has been described with respect to the specific exemplary embodiments, it will be apparent to those skilled in the art that various changes and modifications may be made without departing from the spirit and scope of the invention as defined in the following claims.

What is claimed is:

1. A self-piercing rivet, comprising:
a repair resin disposed in a space formed within the rivet; and
a passage formed between an inner surface forming the space and an outer surface of the rivet and through which the repair resin flows.

2. The self-piercing rivet of claim 1, wherein the repair resin includes a thermosetting resin and a hardener.

3. The self-piercing rivet of claim 2, wherein the thermosetting resin and the hardener are disposed in a separated state by a separation membrane.

4. The self-piercing rivet of claim 1, wherein:
the space is formed in an aperture form at a center of a first end portion of a body portion disposed in an end portion of the rivet; and
the passage is penetrated and formed between an inner surface of the body portion abutting with the repair resin and an outer surface of the body portion.

5. The self-piercing rivet of claim 4, wherein a first end portion of the passage is connected to an inner end portion forming the space.

6. The self-piercing rivet of claim 4, wherein the passage is formed radially based on an axial center of the body portion.

7. The self-piercing rivet of claim 1, wherein a flow groove is formed on the outer surface of the rivet to be connected to a second end portion of the passage.

8. The self-piercing rivet of claim 6, wherein the flow groove is formed in a circumferential direction of the rivet.

9. The self-piercing rivet of claim 6, wherein the flow groove is formed in a circumferential direction of the rivet to have a spiral shape.

10. The self-piercing rivet of claim 1, further comprising:
an insulation unit disposed to surround the outer surface of the rivet and insulating parts abut with the rivet.

11. The self-piercing rivet of claim 10, wherein the insulation unit includes an insulation layer which is formed on the outer surface of the rivet and has a rubber member.

12. The self-piercing rivet of claim 11, wherein the insulation layer is configured by coating a resin on the rubber member.

13. The self-piercing rivet of claim 12, wherein the insulation layer is disposed on the outer surface of the rivet through a resin layer.
